(19) United States
(12) Patent Application Publication
(10) Pub. No.: US 2026/0126551 A1
(43) Pub. Date: May 7, 2026

(54) SENSOR CALIBRATION USING PROJECTED TARGETING FOR VEHICLE OCCUPANT MONITORING

(71) Applicant: NVIDIA Corporation, Santa Clara, CA (US)

(72) Inventors: Jia Chi Wu, San Jose, CA (US); Dae Jin Kim, San Jose, CA (US); Nishant Puri, San Francisco, CA (US); Rajath Bellipady Shetty, Sunnyvale, CA (US); Anshul Jain, San Francisco, CA (US)

(21) Appl. No.: 18/938,930

(22) Filed: Nov. 6, 2024

(51) Int. Cl. G01S 17/894; G01S 7/481; G01S 7/4865; G01S 7/497

(52) U.S. Cl. CPC G01S 17/894; G01S 7/4817; G01S 7/4865; G01S 7/497

(57) ABSTRACT

In various examples, systems and methods are provided for sensor calibration using projected targeting for vehicle occupant monitoring. A target projector may be used to cause a projection of a target to appear at predefined points on boundaries of the gaze regions. Region mapping data that includes 3D coordinates of the predefined points on the boundaries of the gaze regions is generated in the coordinate system of the target projector by pointing the target projector at each of the predefined points on the boundaries of the gaze regions. One or more sensors may be calibrated based at least on a transformation of the region mapping data from the coordinate system of the target projector to a coordinate system of the one or more sensors.

### BACKGROUND

Autonomous and semi-autonomous vehicles rely on machine learning approaches, such as those using deep neural networks (DNNs), to analyze images of an interior space (e.g., cabin, cockpit, etc.) of a vehicle or other machine. An Occupant Monitoring System (OMS) is an example of a system that may be used within a vehicle cabin to perform real-time assessments of occupant or operator presence, gaze, alertness, and/or other conditions. For example, OMS sensors (such as, but not limited to, red green blue (RGB) sensors, infrared (IR) sensors, depth sensors, cameras, and/or other optical sensors) may be used to track an occupant's or an operator's gaze direction, head pose, and/or blinking. This gaze information may be used to determine a level of attentiveness of the occupant or operator (e.g., to detect drowsiness, fatigue, and/or distraction), and/or to take responsive action to prevent harm to the occupant or operator (e.g., by redirecting their attention to a potential hazard, pulling the vehicle over, and/or the like). For example, DNNs may be used to detect that an operator is falling asleep at the wheel, based on the operator's downward gaze toward the floor of the vehicle, and the detection may lead to an adjustment in the speed and direction of the car (e.g., pulling the vehicle over to the side of the road) or an auditory alert to the operator. OMSs often rely on training DNNs with a high volume of training image data that reflects the facial features of different persons to help increase the accuracy of gaze predictions across all persons.

### SUMMARY

Embodiments of the present disclosure relate to sensor calibration using projected targeting for vehicle occupant monitoring. Systems and methods are disclosed that may be used for, among other things, calibrating vehicle or machine occupant monitoring system sensors with respect to region mapping data in a coordinate system of a target projector. The coordinate system of the target projector may serve as the in-cabin frame of reference coordinate system, which may be referred to herein as the cabin coordinate system.

In contrast to conventional calibration systems, the systems and method presented in this disclosure use a target projector to generate region mapping data with three-dimensional (3D) position information for boundary points of regions and calibrate sensors based, at least in part, on the region mapping data. In some embodiments, the target projector may cause a projection of a target to appear at predefined points on boundaries of the regions. The target projector may include a robotic target projector (e.g., a gimbal mounted robotic laser and/or laser range finder). The target projector may include a range-finding sensor (e.g., a laser range finder, an ultrasonic range finder, etc.) to determine a distance from the target projector to the target point where the projected target appears. A representation of the projection point location of the projected target (e.g., in polar coordinates azimuth, elevation, and distance) may be transformed to Cartesian coordinates with respect to the target projector. Accordingly, when the target projector is controlled to produce a projected target at a projection point on an interior surface of the cabin, the 3D coordinates of that projected target in the coordinate system of the target projector (and the cabin coordinate system) may be readily ascertained.

One or more sensors may be calibrated based, at least in part, on a transformation of the region mapping data from the coordinate system of the target projector to a coordinate system of the sensor. Fiducial marker(s) may be included on (e.g., the base of) the target projector to facilitate localization of the one or more sensors in the coordinate system of the target projector. The one or more sensors may capture an image of the fiducial marker(s), and a rotation-translation transform may be derived for the one or more sensors that accounts for the pose (e.g., the rotation and translation) of the sensors. Based on a sensor's rotation-translation transform, the coordinates of the fiducial marker(s) detected in two-dimensional (2D) captured images may be referenced with respect to the coordinate system of the target projector. The accuracy of the region mapping data and the calibration of the one or more sensors may be evaluated by controlling the target projector to point at a known reference and comparing the 3D coordinates of the projected target in the coordinate system of the target projector when pointed at the known reference with an expected position of the known reference (e.g., based on the region mapping data and/or the determined rotation-translation transform).

### BRIEF DESCRIPTION OF THE DRAWINGS

The present systems and methods for sensor calibration using projected targeting for vehicle occupant monitoring are described in detail below with reference to the attached drawing figures, wherein:

FIG. 1 is an illustration of an example flow diagram for a calibration data collection operating environment, in accordance with some embodiments of the present disclosure;

FIG. 2 is an illustration of an example target projector, in accordance with some embodiments of the present disclosure;

FIG. 3 is an illustration of example predefined points on boundaries of regions of a cabin interior, in accordance with some embodiments of the present disclosure;

FIG. 4 is an illustration of example coordinate mapping functions, in accordance with some embodiments of the present disclosure;

FIG. 5 is an illustration of an example flow diagram for sensor calibration, in accordance with some embodiments of the present disclosure;

FIG. 6 is a flow diagram showing an example method for calibrating sensors, in accordance with some embodiments of the present disclosure;

FIG. 7 is a flow diagram showing an example method for reestablishing a coordinate system of the target projector, in accordance with some embodiments of the present disclosure;

FIG. 8 is a flow diagram showing an example method for evaluating region mapping data and/or calibration of a sensor, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

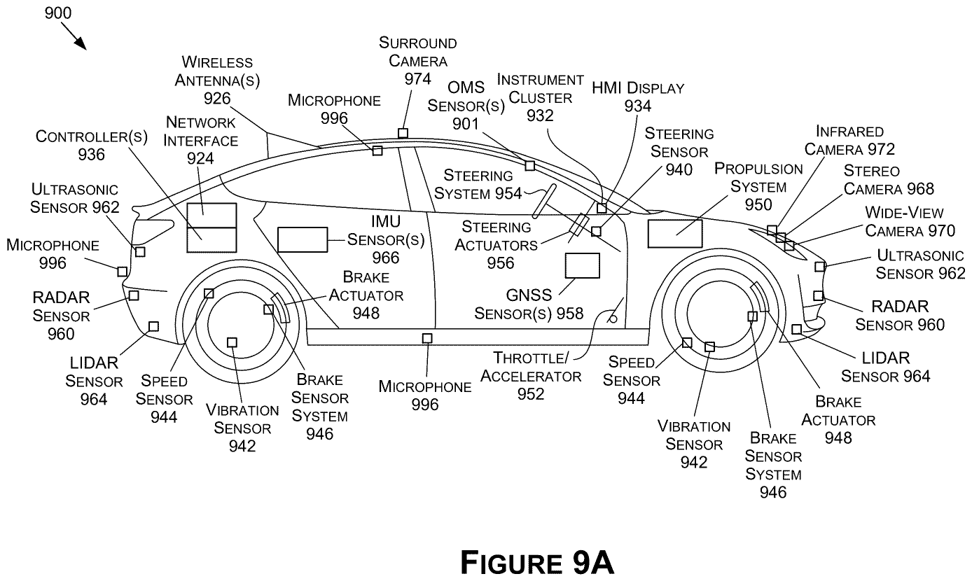

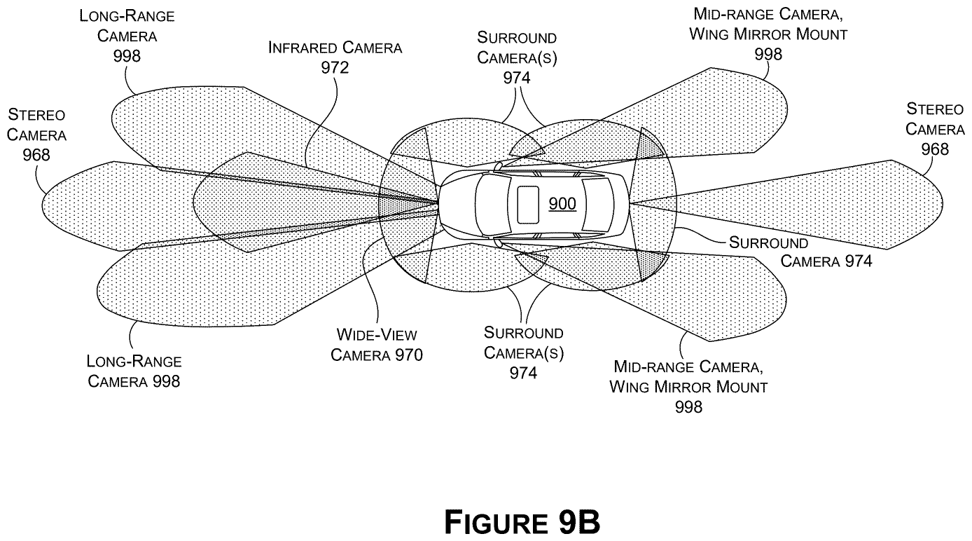

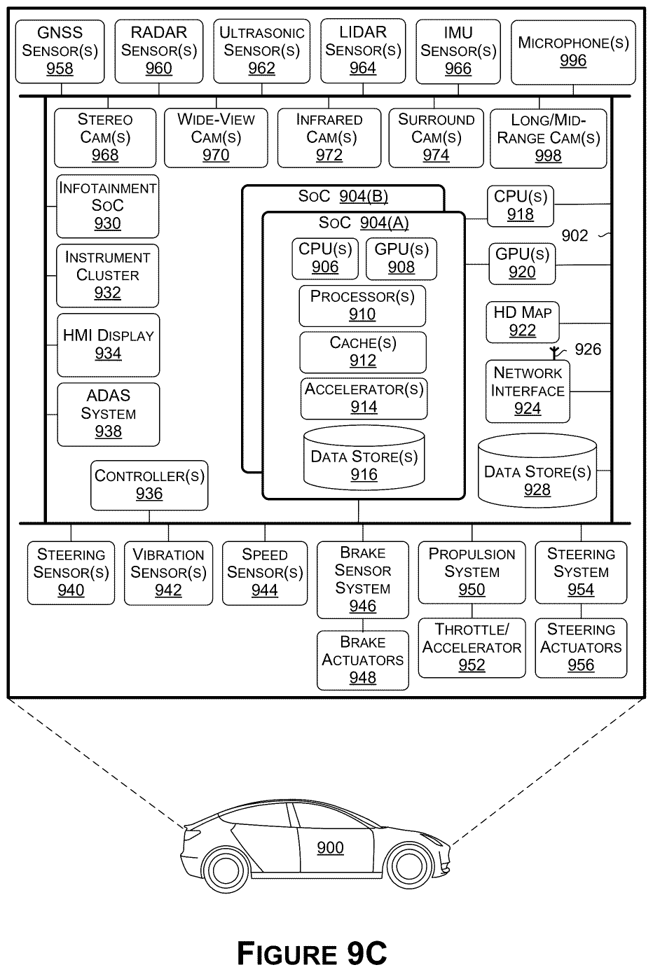

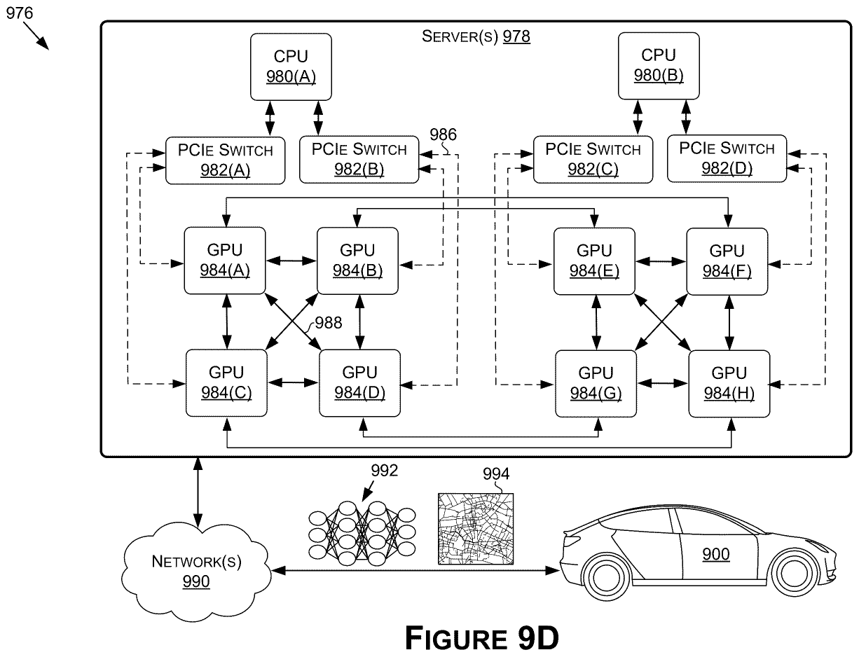

Systems and methods are disclosed related to sensor calibration using projected targeting for vehicle occupant monitoring. Although the present disclosure may be described with respect to an example autonomous or semi-autonomous vehicle or machine 900 (alternatively referred to herein as “vehicle 900” or “ego-machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to generation of calibration data for calibrating in-cabin sensors, this is not intended to be limiting, and the systems and methods described herein may be used in augmented reality, virtual reality, mixed reality, robotics, security and surveillance, autonomous or semi-autonomous machine applications, and/or any other technology spaces where sensor calibration and/or occupant monitoring may be used.

The present disclosure relates to sensor calibration for, as an example and without limitation, occupant monitoring technologies. The systems and methods presented in this disclosure provide for calibrating one or more occupant monitoring system (OMS) sensors (such as RGB sensors, infrared (IR) sensors, depth sensors, cameras, and/or other optical sensors) with respect to an in-cabin frame of reference coordinate system. Occupant monitoring may be used within a vehicle cabin to perform real-time or near real-time assessments of driver and occupant presence, gaze, alertness, and/or other conditions. For example, OMS sensors may be used to track the direction of an occupant's eye gaze, head pose, and/or blinking (e.g., to detect drowsiness, fatigue, and/or distraction), for hand position and/or gesture detection, child and/or pet presence detection, and/or in conjunction with the operation of features such as, but not limited to, seat belt reminders, seat heating and/or smart airbag deployment. However, the extent to which an occupant monitoring system can draw accurate conclusions from OMS sensor data is limited unless features depicted in the images can be accurately represented in the three-dimensional (3D) space of the vehicle or machine cabin and/or other interior space.

Parameters that influence OMS sensor calibration (e.g., with respect to how a 3D space is captured as a two-dimensional image frame) can include both extrinsic and intrinsic parameters. Extrinsic parameters may refer to factors that describe the physical orientation of the sensor, such as rotation and translation (also referred to as roll and tilt), and/or other parameters. Intrinsic parameters may refer to factors that describe sensor optics, such as optical center (also known as the principal point), focal length, optical distortion (e.g., skew) coefficient, field of view or sensory field, and/or other parameters. The extrinsic and intrinsic parameters of a sensor both play a part in how features of a scene within the 3D coordinate space of a vehicle or machine cabin (which may be referred to as the cabin coordinate system) are mapped to the two-dimensional (2D) coordinate space of the plane of a sensor-captured image frame. While the intrinsic parameters of an OMS sensor can be established during manufacture and can be expected to remain reasonably stable, the extrinsic parameters of rotation and translation can change or fluctuate over time, depending on how the OMS sensor is mounted and oriented within the space of the cabin. Moreover, due to factors such as vehicle vibrations, a sensor's rotation and translation may drift over time.

In order to enable the gathering of a high volume of quality training image data, multiple stages of preparation are performed prior to capturing images of occupants in order to calibrate the OMS sensors to particular gaze regions of an interior space. For example, some of the stages include placing OMS sensors in the interior space, defining the boundaries of the gaze regions, measuring the boundaries of the gaze regions in a coordinate system, and calibrating the OMS sensors with respect to the gaze regions and the coordinate system. An example of existing techniques for defining and measuring gaze regions and calibrating OMS sensors includes using manual measurements (e.g., with a tape measure) and graphical fiducial markers such as AprilTags. For the gaze regions, AprilTag grids are attached to different surfaces of the interior space corresponding to the gaze regions and 2D locations of the boundary points for the gaze regions are manually measured relative to the AprilTag grids (e.g., using a tape measure). Images are taken of the AprilTag grids, and computer vision software is used to determine poses of the AprilTag grids. The poses of the AprilTag grid and the manual measurements are then combined to define planar regions by computing the 3D locations of the region's boundary points, and then one of the AprilTag grids is used to align the OMS sensor poses with the gaze region poses.

However, a number of challenges may arise when defining and measuring the gaze regions of an interior space and calibrating the OMS sensors using the techniques that utilize manual measurements and AprilTags. The manual measurements (e.g., with a tape measure) are inherently imprecise due to the limited accuracy of the measuring device and human error associated with manual measurements. Further, when taking images of the AprilTag grids for the computer vision software determinations, there is a lack of clear guidelines for establishing AprilTag poses, which can lead to inconsistent results. For example, some guidelines call for ensuring significant variations in viewpoints and that multiple AprilTag grids are visible in each image, but the thresholds for significant variation and the number of AprilTag grids are not well defined. Furthermore, it is possible that the AprilTag grids will be removed and reinstalled prior to the alignment of the OMS sensor poses with the gaze region poses. If this occurs, any displacement of the AprilTag grid used for this process compared to the original position will cause localization errors for the OMS sensors. Moreover, the existing techniques for validating the calibration of the OMS sensors (e.g., determining reprojection error) are limited and inconclusive for 3D errors.

In contrast to conventional systems, such as those described above, the systems and methods presented in this disclosure may use a target projector to generate region mapping data with 3D position information for gaze region boundary points and to calibrate OMS sensors. In some embodiments, the target projector may cause a projection of a target to appear at predefined points on boundaries of the gaze regions. The target projector may include a robotic target projector (e.g., a gimbal mounted robotic laser and/or laser range finder). The projected targets may be selectively projected onto predefined points on the boundary of the gaze regions, e.g., a test operator may control the target projector to produce a target at the predefined points within the cabin. In some embodiments, the predefined points are labeled or defined on a surface of the interior space using a material (e.g., stickers, felt fabric, film, foil, or the like). Because using the target projector may include activating a laser within a cabin that is occupied by a test occupant, the material used to mark or label the points on the boundary of the gaze regions (e.g., windows, mirrors, instrument panels, and/or dashboards) may comprise an anti-reflective surface treatment that attenuates and/or diffuses reflections. For example, an optical film that scatters light from the interior surface of the cabin (e.g., a film having a matte finish) may be applied to the points on the boundary of the gaze regions (where targets may be projected).

In some embodiments, the target projector may include one or more motors and/or incremental encoders coupled to a controller. The controller may control a motor to rotate a laser (or other visual projection emitter) to point in the direction of a specified polar coordinate (e.g., azimuth and elevation) with respect to an origin defined by the base of the target projector. The controller may activate the laser to produce a projected target at predefined points on the boundaries of the gaze regions at which the laser is pointed. Because a beam of light may be used to produce the projected target, the projected target may be produced at a projection point on the surface of the cabin interior, even if the surface at the projection point is curved, small, or irregularly shaped, as long as there is an unobstructed line of sight between the target projector and the desired projection point.

The target projector may include a range-finding sensor (e.g., a laser range finder, an ultrasonic range finder, etc.) to determine a distance from the target projector to the target point where the projected target appears. In some embodiments, a representation of the 3D position of the projected target (e.g., in polar coordinates azimuth, elevation, and distance) as measured by the target projector may be transformed to (e.g., Cartesian coordinates) a coordinate system of the target projector. Region mapping data that includes 3D coordinates of predefined points on the boundaries of the gaze regions is generated in the coordinate system of the target projector by pointing the target projector at the predefined points on the boundaries of the gaze regions. In some embodiments, a particular gaze region may be defined in the coordinate system of the target projector as the space in between the predefined points on the boundary of the particular gaze region.

Once the region mapping data is generated, an OMS sensor may be calibrated based at least on a transformation of the region mapping data from the coordinate system of the target projector to a coordinate system of the OMS sensor. To facilitate the transformation of the region mapping data to the coordinate system of the OMS sensor, a base of the target projector may include one or more fiducial markers (alternatively referred to as “fiducial marker(s)”) (e.g., AprilTag patterns, ARTag patterns, Quick Response (QR) codes, and/or other patterns) that facilitate determining a 3D position and orientation of the OMS sensor with respect to the target projector coordinate system. By capturing an image frame of the target projector, 2D coordinates of the fiducial marker(s) may be determined with respect to the image frame, and a pose and 3D coordinates of the OMS sensor may be determined with respect to the target projector coordinate system.

In some embodiments, the target projector may be mounted to a repositionable platform in the cabin. The target projector may be removed from the cabin after generating the region mapping data, and reinstalled prior to calibrating the OMS sensor or prior to generating ground truth gaze data using the target projector. In such examples, the localization of the OMS sensor in the region mapping data may be restored by generating a partial region mapping scan and localizing the OMS sensor in the partial region mapping scan using the one or more fiducial markers at the base of the target projector. Generating the partial region mapping scan can include controlling the target projector to project a target at a subset (e.g., three or four) of the predefined points on the boundary of the gaze regions. The full region mapping data can then be aligned with the partial region mapping scan using an optimization process.

In some embodiments, ground truth gaze data may be generated using the target projector by capturing (e.g., using a calibrated OMS sensor) image data (e.g., one or more image frames) of a test occupant's eyes and gaze direction. The image data is captured as the projected targets are selectively projected onto an interior surface of the cabin with the target projector and the gaze of the test occupant (e.g., driver) is directed at the projected target. For example, a test operator may control the target projector to produce a target within the cabin, while the calibrated OMS sensor (e.g., an OMS camera) captures image data of a test occupant. The projection of the target should catch the test occupant's attention as image frames capture the test occupant's eyes as their gaze is directed at the projected target. The captured image frames may be labeled (e.g., tagged) with the 3D coordinates of the projected target and/or the corresponding region to produce ground truth data corresponding to the captured image frames. The labeled ground truth gaze data may be used to train one or more machine learning models such as, but not limited to, a DNN used by an OMS, or for other machine learning applications.

A validation procedure may be performed to determine the accuracy of the region mapping data and/or the calibration of the OMS sensor compared with the behavior of the target projector when used for other tasks (e.g., generating ground truth gaze data). In some embodiments, a test operator may adjust the target projector to project a target at a known reference point (e.g., at the center of the OMS sensor). The 3D position of the projected target is determined and logged, and this logged 3D position can then be compared to an expected or known 3D position of the known reference point (e.g., based on the region mapping data and calibration process) to determine an offset. The determined offset is indicative of the accuracy of the region mapping data and calibration of the OMS sensor, and may be used to update the region mapping data and/or calibration of the OMS sensor. The determined offset can also be compared to a threshold (e.g., selected based on the desired performance of the system), and the region mapping data and/or calibration of the OMS sensor may be validated if the determined offset satisfies the threshold.

While embodiments presented in this disclosure may be implemented in the context of vehicle occupant monitoring systems (including driver monitoring systems) for vehicles such as, but not limited to, non-autonomous vehicles, semi-autonomous vehicles, piloted and un-piloted robots or robotic platforms, warehouse vehicles, off-road vehicles, vehicles coupled to one or more trailers, aircraft, spacecraft, boats, shuttles, emergency response vehicles, construction vehicles, underwater craft, drones, and/or other vehicle types, other embodiments may include determining extrinsic calibration parameters for other types of sensors that capture image frames of other spaces, such as rooms, warehouses, gymnasiums, containers, studios, and/or outdoor spaces.

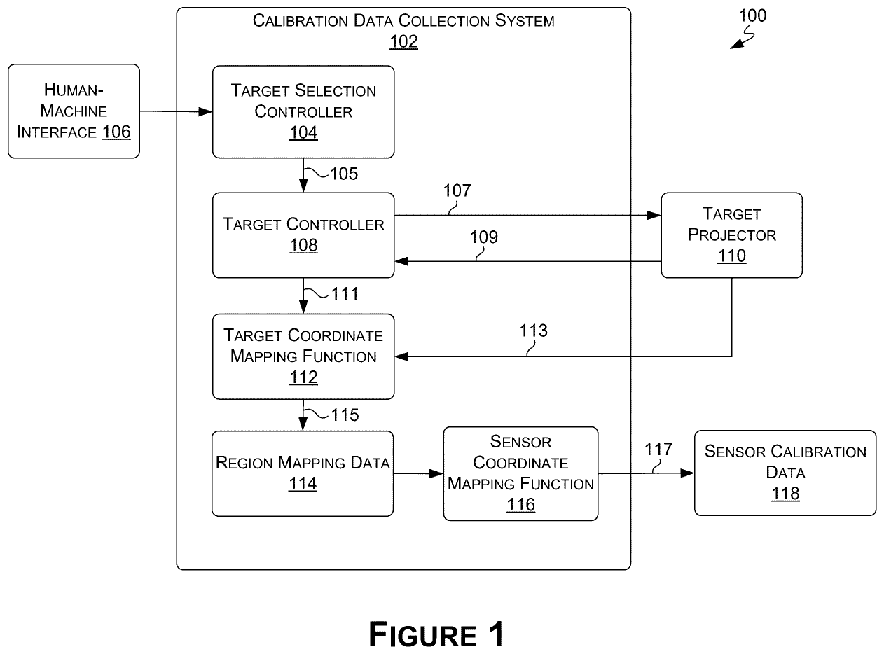

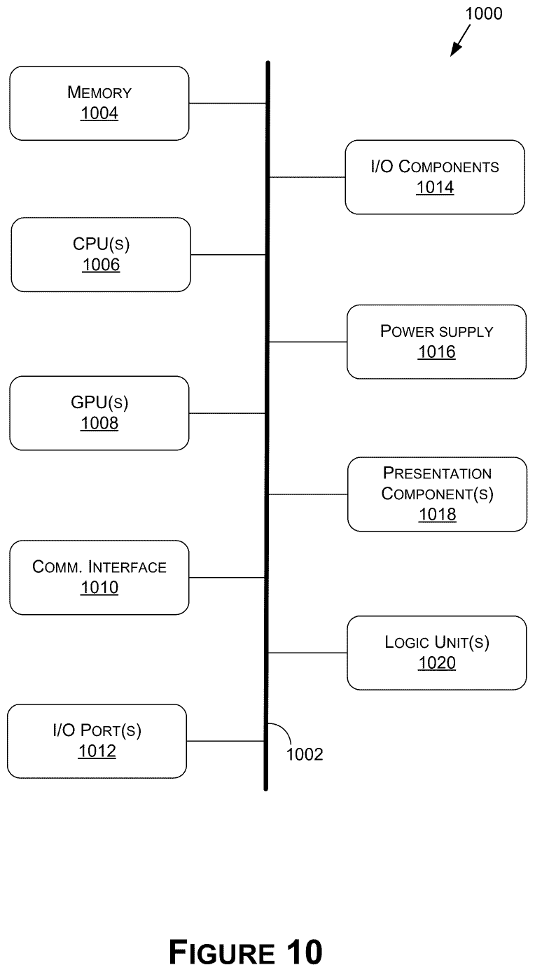

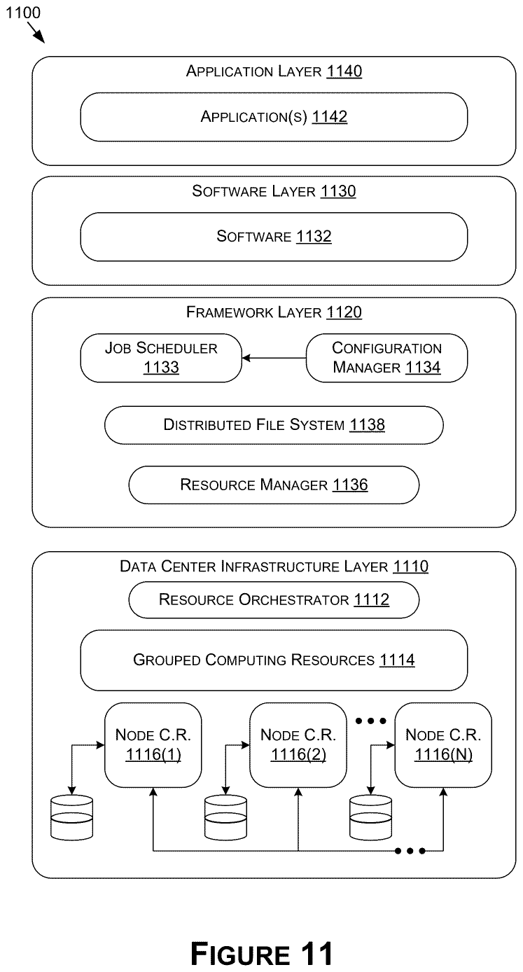

With reference to FIG. 1, FIG. 1 is an example data flow diagram illustrating the interconnection of components and flow of information or data for a calibration data collection system 102, which may be used for calibrating components of an ego-machine (such as autonomous vehicle 900 discussed below with respect to FIG. 9A), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 900 of FIGS. 9A-9D, example computing device 1000 of FIG. 10, and/or example data center 1100 of FIG. 11.

As shown in FIG. 1, the process 100 may include a calibration data collection system 102 that generates region mapping data 114 and sensor calibration data 118 using a target projector 110. The region mapping data 114 may be obtained by the calibration data collection system 102 using a target projector 110 that is controlled to selectively project a target at predefined points on a boundary of one or more regions. The region mapping data 114 may include 3D coordinates of the predefined points on the boundary of the one or more regions based on the location of the projected target when it is pointed at the predefined points.

As illustrated in FIG. 1, in some embodiments, the calibration data collection system 102 may include a target selection controller 104, a target controller 108, a target coordinate mapping function 112, and a sensor coordinate mapping function 116. The selection of targets may be performed by the target selection controller 104. In some embodiments, a test operator (e.g., via a human-machine interface 106) may input to the target selection controller 104 a selection of one or more targets for the target projector 110 to project. The target selection controller 104 may also receive a selection of one or more targets for the target projector 110 to project from an algorithm (e.g., a machine learning model trained to identify regions of interest associated with one of more use cases (e.g., gaze prediction). As discussed herein, the target projector 110 is used to project targets at predefined points on a boundary of a region. To generate a selected projected target, the target selection controller 104 may output a target selection signal 105 to the target controller 108. For example, the target selection signal 105 may include a set of rotation coordinates (e.g., an azimuth and elevation) indicating a direction where the target projector 110 should point to produce the projected target. In some embodiments, a test operator may input the set of rotation coordinates indicating the direction to which the target projector 110 should point to produce the projected target.

Based on the target selection signal 105, the target controller 108 generates one or more projector control signals 107 to control the target projector 110 to rotate to the designated rotation coordinates. When the target controller 108 determines that the target projector 110 reaches the designated rotation coordinates (e.g., based on feedback 109 from the target projector 110), the target controller 108 may control the target projector 110 to activate a visual projection emitter (e.g., a laser) to produce the projected target onto the interior surfaces of the cabin, and activate a range-finding sensor to measure a distance (which may be referred to herein as target depth data) from the target projector 110 to the target point where the projected target appears. The rotation coordinates may be provided (as shown at 111) by the target controller 108 to the target coordinate mapping function 112, and the target depth data may be provided (as shown at 113) by the target projector 110 to the target coordinate mapping function 112. The set of rotation coordinates 111 together with target depth data 113 may represent 3D coordinates of a position of the projected target with respect to the 3D polar coordinate system of the target projector 110. As further discussed herein, the target coordinate mapping function 112 may convert the 3D coordinates of a position of the projected target from the 3D polar coordinate system of the target projector 110 to a different type of coordinate system (e.g., Cartesian coordinates) of the target projector 110. The target coordinate mapping function 112 outputs the 3D coordinates 115 in the coordinate system of the target projector 110 as region mapping data 114. The coordinate system of the target projector 110 may serve as the in-cabin frame of reference coordinate system, which may be referred to herein as the cabin coordinate system.

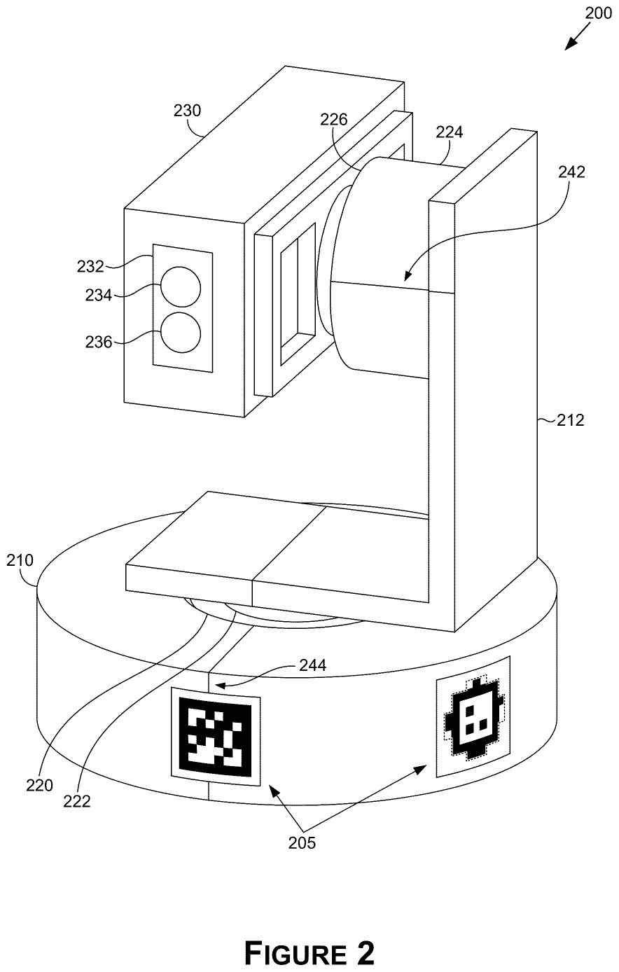

Once the region mapping data is generated, a sensor may be calibrated based at least on a transformation of the region mapping data 114 from the coordinate system of the target projector 110 to a coordinate system of the sensor by the sensor coordinate mapping function 116. To facilitate the transformation of the region mapping data to the coordinate system of the sensor, a base of the target projector may include one or more fiducial markers (e.g., AprilTag patterns, ARTag patterns, QR codes, and/or other patterns as discussed with respect to FIG. 2) that facilitate determining a 3D position and orientation of the sensor with respect to the target projector coordinate system. By capturing an image frame of the target projector 110, 2D coordinates of the fiducial marker(s) may be determined with respect to the image frame, and a pose and 3D coordinates of the sensor may be determined with respect to the coordinate system of the target projector 110. As further discussed herein, the sensor coordinate mapping function 116 may convert the region mapping data 114 from the coordinate system of the target projector 110 to a coordinate system of the sensor. The sensor coordinate mapping function 116 outputs the coordinates 117 in the coordinate system of the sensor as sensor calibration data 118. The sensor calibration data 118 may be used to calibrate the sensor prior to using the sensor to obtain ground truth gaze data.

In some embodiments, after calibration of the one or more sensors (e.g., using the extrinsic calibration parameters discussed herein), ground truth gaze data may be generated using the target projector 110 by capturing (e.g., using a calibrated sensor) image data (e.g., one or more image frames) of a test occupant's eyes and gaze direction. The image data is captured as the projected targets are selectively projected onto an interior surface of the cabin with the target projector 110 and the test driver's gaze is directed at the projected target. For example, a test operator (e.g., via a human-machine interface 106, the target selection controller 104, and the target controller 108) may control the target projector 110 to produce a target within the cabin while the calibrated OMS sensor (e.g., an OMS camera such as the one or more OMS sensor(s) 901 and/or other interior cameras discussed with respect to FIGS. 9A and 9B) captures image data of a test occupant. The projection of the target should catch the test driver's attention as image frames capture the test occupant's eyes as their gaze is directed at the illumination of the projected target. The captured image frames may be labeled (e.g., tagged) with the 3D coordinates of the projected target and/or the corresponding region to produce ground truth data corresponding to the captured image frames.

Referring now to FIG. 2, FIG. 2 illustrates an example robotic target projector 200, which may be used to implement the target projector 110, in accordance with some embodiments of the present disclosure. The target projector 200 may comprise a mounting arm 212 rotatably coupled to a base 210 and further rotatably coupled to a projector member 230. In some embodiments, the base 210 and mounting arm 212 form a set of gimbals for pivoting the projector member 230 with respect to a set of orthogonal pivot axes (e.g., an elevation axis and an azimuth axis). The base 210 and mounting arm 212 may be coupled via a first motor 222 (e.g., an azimuth motor) to control the rotational position (e.g., the rotational orientation) of the projector member 230 with respect to the azimuth axis. In some embodiments, an azimuth motor encoder 220 tracks the position (and/or speed) of a motor shaft of the azimuth motor encoder 220 to provide closed loop feedback signal to the target controller 108 for controlling and/or monitoring the rotation of the projector member 230 with respect to the azimuth axis. Similarly, the projector member 230 and mounting arm 212 may be coupled via a second motor 224 (e.g., an elevation motor) to control the rotational position of the projector member 230 with respect to the elevation axis. In some embodiments, an elevation motor encoder 226 tracks the position (and/or speed) of a motor shaft of the elevation motor 224 to provide a closed loop feedback signal to the target controller 108 for controlling and/or monitoring the rotation of the projector member 230 with respect to the elevation axis. In some embodiments, the azimuth motor encoder 220 may define an azimuth origin 244 (e.g., azimuth coordinate of zero degrees) for positioning the projector member 230 based on monitoring the motor shaft of the azimuth motor encoder 220. Similarly, the elevation motor encoder 226 may define an elevation origin 242 (e.g., elevation coordinate of zero degrees) for positioning the projector member 230 based on monitoring the motor shaft of the elevation motor 224.

As shown in FIG. 2, the projector member 230 may include a visual projection emitter 234 (e.g., a laser and/or light-emitting diode (LED) device) that when activated generates the projected target on the cabin surface. The projector member 230 may include a range-finding sensor 236 (e.g., a laser range finder, an ultrasonic range finder, etc.) to determine a distance from the target projector to the target point where the projected target appears. The visual projection emitter 234 and range-finding sensor 236 may be separate devices or at least partially integrated together as a visual projection emitter/range-finding sensor 232 (e.g., a laser range finder that uses a visible laser).

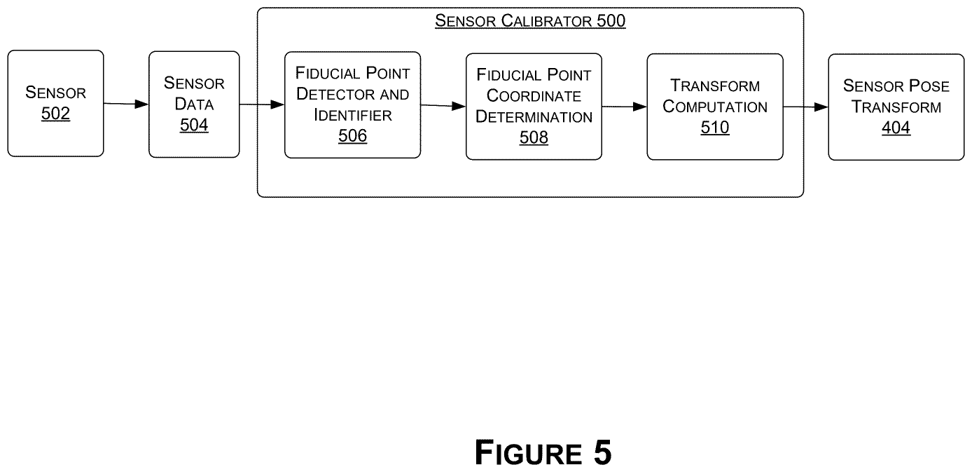

In some embodiments, the base 210 of the target projector 200 may include one or more fiducial markers 205 (e.g., AprilTag patterns, ARTag patterns, QR codes, and/or other patterns) that localize and facilitate determining a 3D position and orientation of the base of the target projector 200 (e.g., the pose of target projector 200) with respect to the sensor coordinate system. As explained in greater detail below with respect to FIG. 5, by capturing an image frame of the target projector 200 and the one or more fiducial markers 205, a sensor pose transform may be computed and used by the sensor coordinate mapping function 116 to transform the region mapping data 114 from 3D coordinates 115 in the coordinate system of the target projector 110 to coordinates 117 in the coordinate system of a sensor.

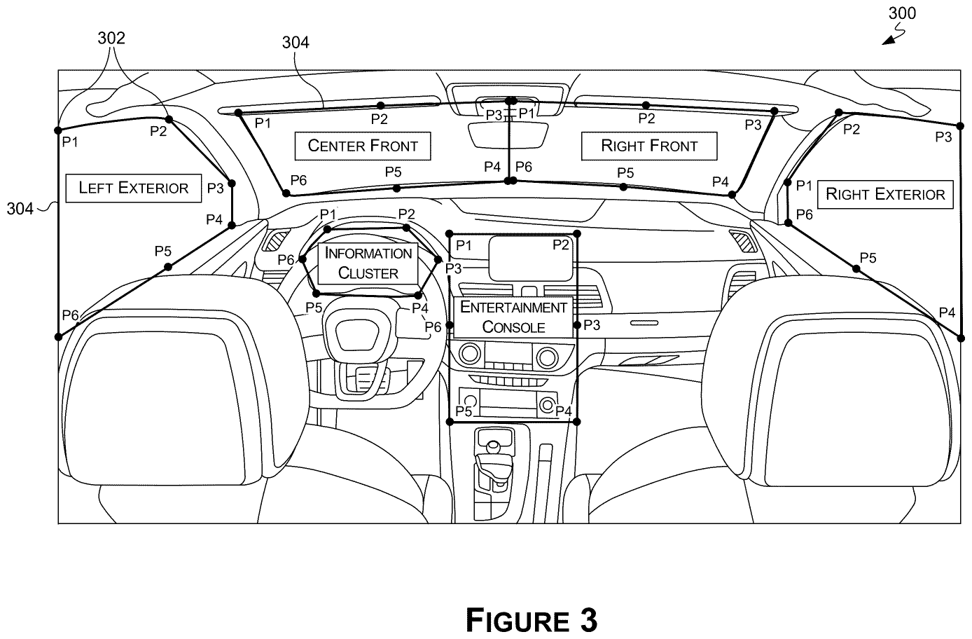

Now referring to FIG. 3, FIG. 3 at 300 illustrates an example cabin interior with a plurality of predefined points 302 marked or labeled within the cabin interior. A set of the predefined points 302 is used to define a boundary 304 of a particular region (e.g., a gaze region). In the example shown in FIG. 3, six predefined points 302 (labeled P1-P6) are included in a set for the boundary 304 of a particular gaze region. However, it should be understood that a different number of predefined points 302 (e.g., four, eight, ten, etc.) could also be used depending on the shape of the boundary 304 (and the particular region defined by the boundary 304) and the precision desired for defining the boundary 304 (and the particular region defined by the boundary 304) in the region mapping data 114 and the sensor calibration data 118.

The number of predefined points 302 for defining a boundary 304 and the location of the predefined points 302 within the cabin may be selected by the test operator. The number of predefined points 302 for defining a boundary 304 and/or the location of at least one of the predefined points 302 within the cabin may also be selected using an algorithm (e.g., a machine learning model trained to identify regions of interest associated with one of more use cases (e.g., gaze prediction)). The selected predefined points 302 may be marked or labeled on a surface of the interior space using a material (e.g., stickers, felt fabric, film, foil, or the like). Operation of the target projector 110 may include activating a laser within a cabin that is occupied by a test occupant, so the material used to label or define the predefined points 302 on the boundary 304 of the regions may comprise an anti-reflective surface treatment that attenuates and/or diffuses reflections. For example, an optical film that scatters light from the interior surface of the cabin (e.g., a film having a matte finish) may be applied to the predefined points 302 on the boundary 304 of the regions (where targets may be projected).

The target projector 110 may be controlled (e.g., by a test operator) to cause a projection of a target to appear at the predefined points 302 within the cabin interior. The target controller 108 may activate a laser of the target projector 110 to produce a projected target at the predefined points 302 on the boundaries of the regions at which the laser is pointed. Because a beam of light may be used to produce the projected target, the projected target may be produced at a projection point on the surface of the cabin interior, even if the surface at the projection point is curved, small, or irregularly shaped, as long as there is an unobstructed line of sight between the target projector 110 and the desired projection point. The 3D coordinates of the projection of the target at a particular predefined point 302 may be determined and recorded, which are indicative of the location of the predefined point 302 in the coordinate system of the target projector 110. The process may be repeated for the predefined points 302 on the boundary 304 of a particular region in order to define the boundary 304 of the region in the coordinate system of the target projector 110. It should be noted that the identifiers P1-P6 are used for identification purposes of the distinct predefined points 302 in FIG. 3 of the present disclosure, but this does not imply a particular order for determining locations (e.g., starting with P1). The sequence of projecting a target at the selected predefined points 302 may be in any order (e.g., determined by a test operator or an algorithm) and the present disclosure is not limited in this regard. Further, these identifiers do not need to be included (e.g., labeled) within the cabin interior and are shown in FIG. 3 for explanation purposes.

The boundary 304 for a particular region may be defined by lines extending through space between the locations (3D position) of the predefined points 302 that define the boundary 304. A particular boundary 304 may be defined by straight or curved lines extending between the predefined points 302 that define the particular boundary 304 depending on the predefined points 302 that define the particular boundary 304. In the example shown in FIG. 3, the boundary 304 of the “Left Exterior” region is defined by lines that extend between the predefined points 302 associated with the boundary 304 and the “Left Exterior” region.

A particular region may be defined by the space within (and including) the boundary 304 for that region. In some embodiments, the particular region is modeled as a 2D or 3D surface that includes all of the predefined points 302 defining the boundary 304 of the particular region. In the example shown in FIG. 3, the “Left Exterior” region also includes the space within the boundary 304 of that region, so the “Left Exterior” region includes the boundary 304 associated with the “Left Exterior” region and the space within that boundary 304.

The additional regions shown in FIG. 3 (e.g., “Center Front” region, “Information Cluster” region, etc.) may be defined in a similar manner as described above with respect to the “Left Exterior” region. The techniques described herein may be used to generate region mapping data 114 and sensor calibration data 118 for one or more regions (e.g., gaze regions) within the cabin.

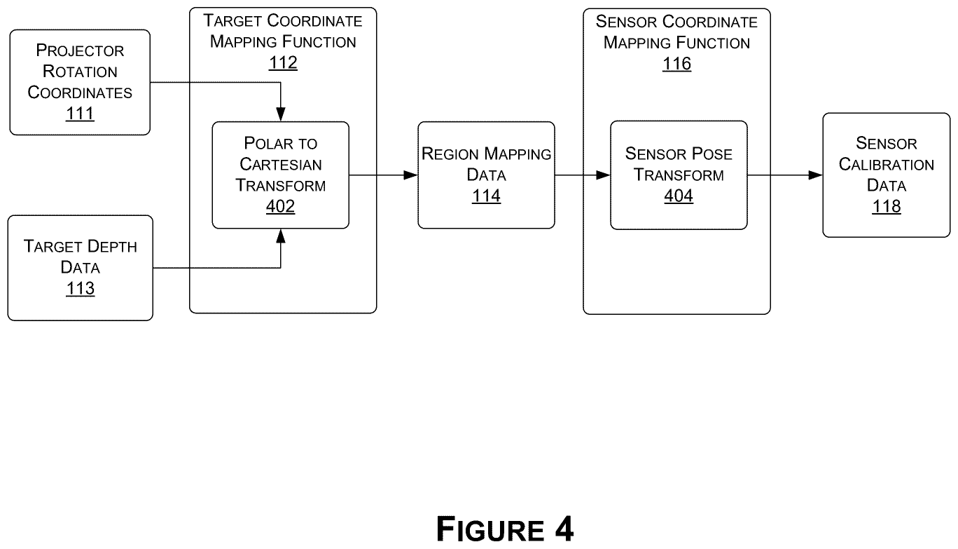

Referring now to FIG. 4, FIG. 4 further illustrates an example target coordinate mapping function 112 and a sensor coordinate mapping function 116, in accordance with some embodiments of this disclosure. In some embodiments, the target coordinate mapping function 112 inputs the rotation coordinates 111 (e.g., comprising polar coordinates azimuth and elevation coordinates) and target depth data 113 (comprising a distance) and performs a polar to Cartesian transform 402 to map those polar coordinates into a set of 3D Cartesian coordinates with respect to a coordinate system of the target projector 110, which are output as the region mapping data 114. The 3D Cartesian coordinates may comprise a set of x, y, and z Cartesian coordinates representing a position of the protected target with respect to an origin defined by the location of the target projector 110 (e.g., which may be defined using the fiducial markers 205).

Using a sensor pose transform 404, the sensor coordinate mapping function 116 may convert the region mapping data 114 from the coordinate system of the target projector 110 into the coordinate system of a sensor (e.g., OMS sensor 901) and outputs the converted coordinates 117 as sensor calibration data 118. Further, based on a sensor pose transform 404, the coordinates of features detected in 2D captured images may be referenced with respect to the coordinate system of the target projector 110. As discussed herein with respect to FIG. 5, the sensor pose transform 404 may account for the extrinsic parameters that describe the physical orientation of the sensor, such as rotation and translation (also referred to as roll and tilt) with respect to the coordinate system of the target projector 110.

Now referring to FIG. 5, FIG. 5 illustrates an example sensor calibrator 500, which may be used to compute the sensor pose transform 404 based on sensor data 504 from a sensor 502 that captures an image frame of the target projector 110 and the one or more fiducial markers 205. A rotation-translation transform corresponding to target projector 110 may be computed by the sensor calibrator 500 that may comprise, for example, a fiducial point detector and identifier 506, a fiducial point coordinate determination function 508, and a transform computation function 510. Input to the sensor calibrator 500 may include, but is not limited to, one or more of sensor data 504, sensor intrinsic parameters, or a known 3D position of the fiducial marker(s) 205 in the coordinate system of the target projector 110.

The sensor 502 may be positioned in the cabin interior that includes the target projector 110. The sensor 502 may capture sensor data 504 (e.g., image data comprising one or more image frames) of the target projector 110. The sensor 502 may include, without limitation, any type of optical sensor (e.g., RGB optical sensor(s), IR optical sensor(s), RGB-IR optical sensor(s), depth sensor(s), camera(s), and/or other optical sensor(s) such as but not limited to those described herein with respect to the vehicle 900 and/or other vehicles or objects - such as robotic devices, virtual reality (VR) systems, augmented reality (AR) systems, mixed reality systems, etc., in some examples). The sensor data 504 may include, without limitation, sensor data from any type of optical sensor(s) used for sensor 502 (e.g., OMS sensor 901).

In some embodiments, the sensor data 504 may correspond to sensor data comprising 2D image frames generated using one or more in-cabin sensors 502, such as one or more in-cabin cameras, in-cabin near-infrared (NIR) sensors, in-cabin microphones, and/or the like. The sensor data 504 may correspond to sensors with a sensory field or field of view internal to the vehicle 900 (e.g., cameras with the occupant(s), such as the driver, in its field of view).

In some embodiments, the sensor calibrator 500 may be functionally integrated as a component of the occupant monitoring system of a vehicle 900 and/or of the calibration data collection system 102. The calibration data collection system 102 may, for example, use the rotation-translation transform as the sensor pose transform 404. The fiducial point detector and identifier 506 may analyze the sensor data 504 to detect the presence of the one or more fiducial markers 205 on the base 210 (or other location) of the target projector 110. The fiducial point detector and identifier 506 may execute one or more machine learning algorithms, deep neural networks, computer vison algorithms, image processing algorithms, mathematical algorithms, and/or other technologies, to determine whether images of one or more fiducial markers 205 are represented by or correspond to the sensor data 504 and/or which portion of the sensor data 504 (or a representation thereof) includes the one or more fiducial markers 205. For example, the fiducial point detector and identifier 506 and/or other components of the sensor calibrator 500 may be implemented using any type of machine learning model or algorithm, such as a machine learning model(s) using linear regression, logistic regression, decision trees, support vector machines (SVM), Naïve Bayes, k-nearest neighbor (k-NN), K means clustering, random forest, dimensionality reduction algorithms, gradient boosting algorithms, neural networks (e.g., auto-encoders, convolutional, recurrent, perceptrons, long/short-term memory/LSTM, Hopfield, Boltzmann, deep belief, deconvolutional, generative adversarial, liquid state machine, etc.), areas-of-interest detection algorithms, computer vision algorithms, and/or other types of algorithms or machine learning models.

For the fiducial marker(s) 205 detected by the fiducial point detector and identifier 506, the fiducial point coordinate determination function 508 determines a 2D coordinate within the image space of an image frame of sensor data 504. 2D coordinates (e.g., u and v) may be established for a fiducial marker 205 based on the location of the fiducial marker 205 with respect to the image space of the sensor data 504. For the set of one or more of the fiducial markers 205 detected by the fiducial point detector and identifier 506, the sensor calibrator 500 also uses the known position of the fiducial marker 205 in the coordinate system of the target projector 110.

The sensor calibrator 500 may apply transform computation function 510, which comprises a pose computation algorithm that may be used to estimate rotation and translation vectors that represent the pose of the sensor 502, which captures the image frame, with respect to the coordinate system of the target projector 110. For example, transform computation function 510 may compute a rotation-translation transform as a rotation-translation matrix comprising rotation vector (R) and translation vector (T) that may be used for the sensor pose transform 404. The rotation and translation vectors may define a rotation-translation transform that may then be used as a calibration parameter for an occupant monitoring system—that is, a system that performs one or more occupant monitoring functions using the sensor such as, but not limited to, identifying faces, facial landmarks, eye information, gaze detection, occupant position, seat position, and/or other operations. In some embodiments, the pose computation algorithm may include one or more computer vision algorithms such as an algorithm based on the Open Source Computer Vision Library (OpenCV), Eigen library, bundle adjustment optimization, Random Sample Consensus (RANSAC) optimization, or other algorithm. Further information on computing rotation-translation transforms using 2D image frames is provided by U.S. patent application Ser. No. 17/935,473, titled “MULTI-MODAL SENSOR CALIBRATION FOR IN-CABIN MONITORING SYSTEMS AND APPLICATIONS,” filed Sep. 26, 2022, and U.S. patent application Ser. No. 17/935,465, titled “SENSOR CALIBRATION USING FIDUCIAL MARKERS FOR IN-CABIN MONITORING SYSTEMS AND APPLICATIONS,” filed Sep. 26, 2022, both of which are incorporated herein in their entirety.

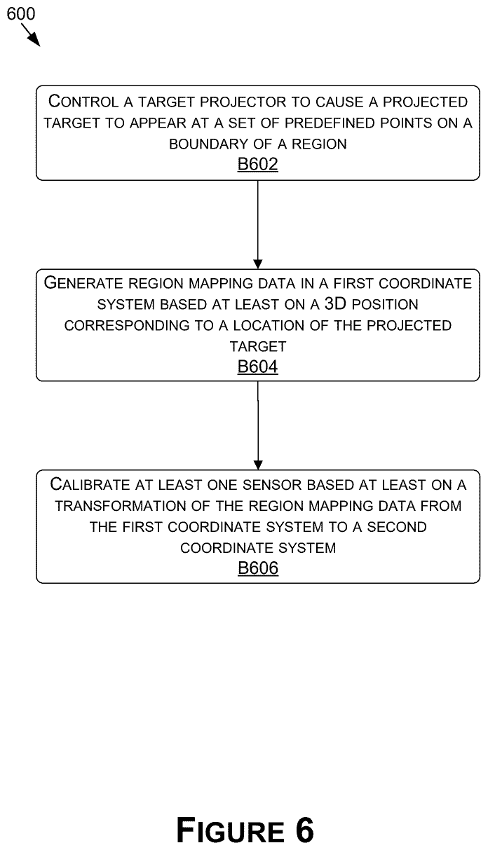

Now referring to FIG. 6, FIG. 6 is a flow diagram showing an example method 600 for generating calibration data, in accordance with some embodiments of the present disclosure. It should be understood that the features and elements described herein with respect to the method 600 of FIG. 6 may be used in conjunction with, in combination with, or substituted for elements of any of the other embodiments discussed herein and vice versa. Further, it should be understood that the functions, structures, and other descriptions of elements for embodiments described in FIG. 6 may apply to like or similarly named or described elements across any of the figures and/or embodiments described herein and vice versa.

Each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the calibration data collection system 102 of FIG. 1. However, this method may additionally or alternatively be executed by any one system, or any combination of systems, including, but not limited to, those described herein.

The method 600, at block B602, includes controlling a target projector to cause a projected target to appear at a set of predefined points on a boundary of a region. Targets generated by a target projector are produced by directing a beam of light at the predefined points on the boundary. Such projected targets may be produced at a projection point on the surface of the cabin interior, even if the surface at the projection point is curved, small, or irregularly shaped, as long as there is an unobstructed line of sight between the target projector and the desired projection point. The target projector may include a robotic target projector (e.g., a gimbal mounted robotic laser and/or laser range finder) that is rotated to direct a visual projection emitter (e.g., a laser and/or LED device) and range finder to aim at the predefined points on the boundary. When activated, the projection emitter generates the projected target on the cabin surface, and the range finder determines a distance from the target projector to the target point where the projected target appears. The visual projection emitter and range finder may be separate devices or at least partially integrated together. For example, as described with respect to FIG. 1, region mapping data 114 may be obtained by the calibration data collection system 102 using a target projector 110 that is controlled to selectively project a target at predefined points on a boundary of one or more regions. The calibration data collection system 102 may include a target selection controller 104, a target controller 108, a target coordinate mapping function 112, and a sensor coordinate mapping function 116. The selection of targets may be performed by the target selection controller 104 (e.g., based on input from a test operator or a machine learning model trained to select the targets).

The method 600, at block B604, includes generating region mapping data in a first coordinate system based on a 3D position corresponding to a location of the projected target. The region mapping data can include 3D positions of the predefined points on the boundary of a region. For example, for an embodiment using a robotic target projector (e.g., target projector 200), 3D coordinates of a projected target may be established in terms of polar coordinates (altitude, elevation, depth, etc.) with respect to the target projector. The 3D coordinates may be transformed to Cartesian coordinates with respect to the target projector. For example, as described with respect to FIG. 4, the target coordinate mapping function 112 may convert the 3D coordinates of the position of the projected target from a 3D polar coordinate system of the target projector 110 to a Cartesian coordinate system of the target projector 110. In some embodiments, the 3D coordinates in the Cartesian coordinate system of the target projector 110 are output as the region mapping data 114.

The method 600, at block B606, includes calibrating at least one sensor based on a transformation of the region mapping data from the first coordinate system to a second coordinate system. The region mapping data may be transformed from the first coordinate system (e.g., a coordinate system of the target projector) to a second coordinate system (e.g., the coordinate system of the sensor). In some embodiments, a sensor pose transform may be used to convert the 3D Cartesian coordinates in the target projector coordinate system into the coordinates of the sensor coordinate system. Calibrating the sensor may include localizing the sensor in the coordinate system of the target projector and providing the region mapping data in the coordinate system of the at least one sensor. For example, as described with respect to FIGS. 4-5, a sensor pose transform 404 may be determined using the sensor calibrator 500 and the region mapping data 114 may be transformed into the coordinate system of the sensor (and output as sensor calibration data 118) by the sensor coordinate mapping function 116 using the sensor pose transform 404. The sensor pose transform may also be saved to memory as an extrinsic calibration parameter for the sensor, which may be used by a system (e.g., an OMS) to translate features in sensor data obtained from the sensor (e.g., captured images of a test occupant's gaze) into the coordinate system of the target projector.

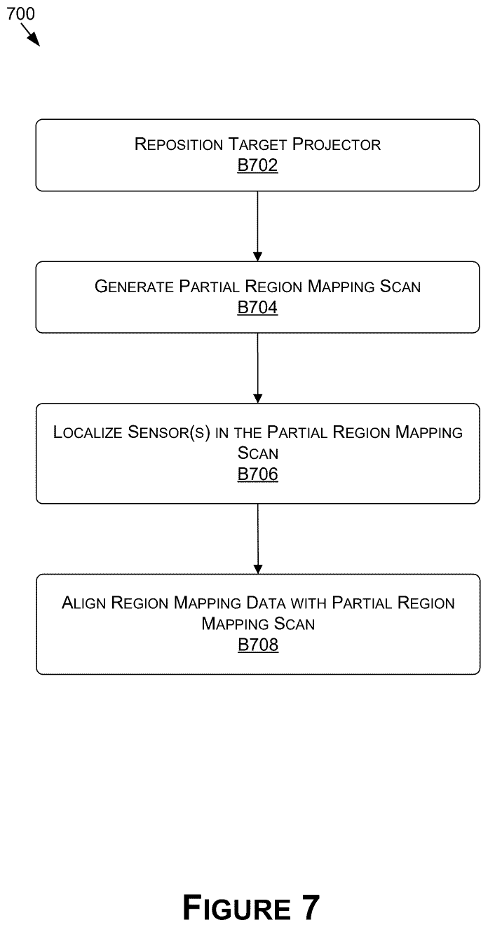

Now referring to FIG. 7, FIG. 7 is a flow diagram showing an example method 700 for reestablishing a coordinate system of the target projector, in accordance with some embodiments of the present disclosure. It should be understood that the features and elements described herein with respect to the method 700 of FIG. 7 may be used in conjunction with, in combination with, or substituted for elements of any of the other embodiments discussed herein and vice versa. Further, it should be understood that the functions, structures, and other descriptions of elements for embodiments described in FIG. 7 may apply to like or similarly named or described elements across any of the figures and/or embodiments described herein and vice versa.

Each block of method 700, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 700 is described, by way of example, with respect to the calibration data collection system 102 of FIG. 1. However, this method may additionally or alternatively be executed by any one system, or any combination of systems, including, but not limited to, those described herein.

The method 700, at block B702, includes repositioning a target projector. As discussed herein, the target projector used to generate the region mapping data may be mounted to a repositionable platform in the cabin. The target projector may be removed from the cabin after generating the region mapping data and then reinstalled prior to calibrating the sensor or prior to generating ground truth gaze data using the target projector, as discussed herein. Flexibility in positioning the reinstalled target projector is desirable (e.g., to position the target projector such that it may be used to project gaze targets when a test occupant is in the cabin), and the target projector may be positioned at a different location within the cabin when reinstalled compared to its position when the region mapping data was obtained. For example, the base 210 of the target projector 200, as described with respect to FIG. 2, may be repositionable such that the position of the target projector 200 may be changed within the cabin after collection of the region mapping data 114.

The method 700, at block B704, includes generating a partial region mapping scan. The partial region mapping scan is generated using the repositioned target projector. Generating the partial region map scanning may include controlling the repositioned target projector to cause a projected target to appear at a subset (e.g., three or four) of the predefined points used to generate the region mapping data and determining the 3D positions of the subset of the predefined points in the coordinate system of the repositioned target projector. For example, in a manner similar to that described with respect to FIG. 1, a partial region mapping scan may be obtained by the calibration data collection system 102 as the repositioned target projector 110 is controlled to selectively project a target at the subset of the predefined points 302 on a boundary 304 of one or more regions. The selection of predefined points 302 may be performed by the target selection controller 104 (e.g., based on input from a test operator and/or an algorithm (e.g., a machine learning model trained to identify and select the subset of predefined points for the partial region mapping scan).

The method 700, at block B706, includes localizing a sensor in the partial region mapping scan. The sensor may be positioned in the cabin interior that includes the repositioned target projector, and the sensor may capture one or more image frames that include the repositioned target projector. The repositioned target projector may include the fiducial marker(s) at the base, and the 2D coordinates of the fiducial marker(s) may be determined based on the location of the fiducial marker(s) in the one or more image frames. For example, as described with respect to FIG. 2, the base 210 of the target projector 200 may include the fiducial marker(s) 205, which may be captured in one or more image frames by a sensor 502 (e.g., OMS sensor 901). The position of the fiducial marker(s) are known in the coordinate system of the repositioned target projector. A pose computation algorithm may be used to estimate rotation and translation vectors (e.g., a sensor pose transform) that represent the pose of the sensor that captured the image frame with respect to the coordinate system of the repositioned target projector. The sensor pose transform may be saved to memory as an extrinsic calibration parameter for the sensor, which may be used by a system (e.g., an OMS) to translate features in sensor data obtained from the sensor (e.g., captured images of a test occupant's gaze) into the coordinate system of the repositioned target projector. The sensor pose transform 404 for the sensor 502 may be determined in manner similar to that described with respect to FIG. 5 using the sensor calibrator 500 that includes the fiducial point detector and identifier 506, the fiducial point coordinate determination function 508, and the transform computation function 510.

The method 700, at block B708, includes aligning region mapping data with the partial region mapping scan. Once the sensor is localized in the partial region mapping scan, the region mapping data may be aligned with the partial region mapping scan using the sensor pose transforms for the sensor with respect to the cabin coordinate system and with respect to the coordinate system of the repositioned target projector. In some embodiments, a difference between the two sensor pose transforms is determined and used to translate the region mapping data into the coordinate system of the repositioned target projector. An optimization process (e.g., a numerical optimization process) may be used during this alignment operation.

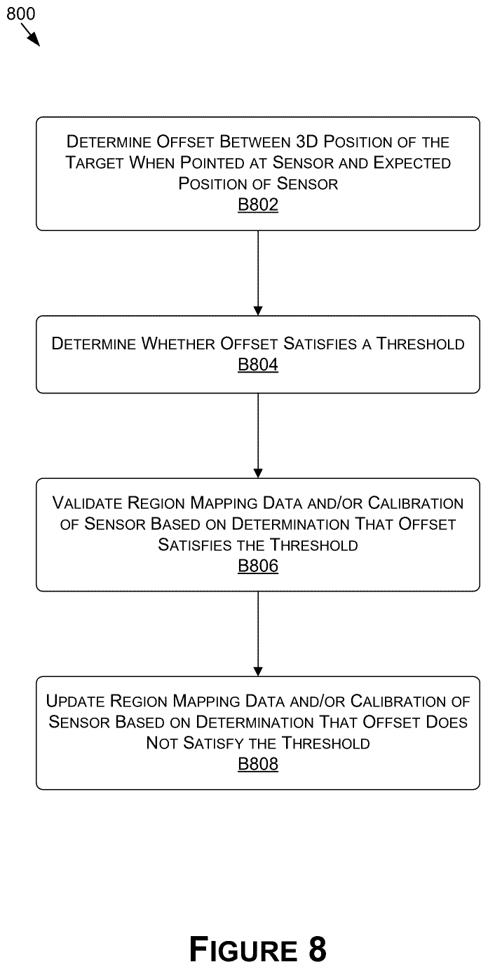

Now referring to FIG. 8, FIG. 8 is a flow diagram showing an example method 800 for evaluating region mapping data and/or calibration of a sensor, in accordance with some embodiments of the present disclosure. It should be understood that the features and elements described herein with respect to the method 800 of FIG. 8 may be used in conjunction with, in combination with, or substituted for elements of any of the other embodiments discussed herein and vice versa. Further, it should be understood that the functions, structures, and other descriptions of elements for embodiments described in FIG. 8 may apply to like or similarly named or described elements across any of the figures and/or embodiments described herein and vice versa.

Each block of method 800, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 800 is described, by way of example, with respect to the calibration data collection system 102 of FIG. 1. However, this method may additionally or alternatively be executed by any one system, or any combination of systems, including, but not limited to, those described herein.

The method 800, at block B802, includes determining an offset between a 3D position of a target when pointed at a sensor and an expected position of the sensor. A test operator may adjust the target projector to project a target at one or more points corresponding to a location of the sensor (e.g., the center of the sensor), and the 3D position of the target when pointed at the sensor is determined. The determined 3D position of the target when pointed at the sensor may include the rotation coordinates (e.g., comprising polar coordinates azimuth and elevation coordinates) and the target depth data (comprising a distance) for the target projector when controlled to point at the sensor, or may include Cartesian coordinates after conversion from the rotation coordinates and target depth data. The expected position of the sensor is based on a computed 3D position of the sensor in the coordinate system of the target projector that may be determined based on the region mapping data and the extrinsic calibration parameter(s) generated during the localization of the sensor. For example, the position of the sensor is known in the coordinate system of the sensor, and the computed 3D position may be determined by transforming the known position of the sensor in the coordinate system of the sensor by reversing the sensor pose transform and reversing the polar to Cartesian transform, if applicable. For example, the reverse operation of the sensor pose transform 404 and the polar to Cartesian transform 402 described with respect to FIG. 4 may be performed to obtain the position of the sensor 502 in the coordinate system of the target projector 110.

The offset is the difference between the determined 3D position of a target when pointed at a sensor and the expected position of the sensor. The offset may be reflected as a single value (e.g., absolute value of a 3D vector) indicating the distance between the determined 3D position and the expected 3D position. The offset may also be reflected as individual components of the 3D vector indicating the difference between the determined 3D position and the expected 3D position. For example, the offset can be represented with the individual differences of the polar coordinate components (azimuth component, elevation component, and depth data component) or with the individual differences of the Cartesian coordinate components (e.g., x component, y component, and z component). The offset is indicative of the accuracy of the region mapping data and the calibration of the sensor.

The method 800, at block B804, includes determining whether the offset satisfies a threshold. The threshold may be indicative of an acceptable level of error for the calibration and may be selected based on the desired performance of the system. The threshold can be a single value (e.g., where the offset is reflected as a single value) or the threshold may have several components (e.g., corresponding to the different components of the offset).

The method 800, at block B806, includes validating the region mapping data and/or calibration of a sensor based on a determination that the offset satisfies the threshold. If the single value of the offset satisfies the threshold (e.g., is less than or equal to the threshold value), then the accuracy of the calibration meets the requirements for the system. Similarly, if the individual components of the offset satisfy the corresponding components of the threshold (e.g., each individual component of the offset is less than or equal to the threshold value for the corresponding threshold component), then the accuracy of the calibration meets the requirements for the system. The validity of the region mapping data and/or the calibration of the sensor may be confirmed in response to the offset satisfying the threshold. In some embodiments, a status indicator for the region mapping data 114 and/or the sensor calibration data 118 generated using the calibration data collection system 102, as described with respect to FIG. 1, may be updated to indicate that the region mapping data 114 and/or sensor calibration data 118 has been validated.

The method 800, at block B808, includes updating the region mapping data and/or calibration of the sensor based on a determination that the offset does not satisfy the threshold. If the single value of the offset does not satisfy the threshold (e.g., is greater than the threshold value), then the accuracy of the calibration does not meet the requirements for the system. Similarly, if any of the individual components of the offset do not satisfy the corresponding components of the threshold (e.g., one or more individual components of the offset are greater than the threshold value for the corresponding threshold component), then the accuracy of the calibration does not meet the requirements for the system. In response to the offset (or individual components of the offset) not satisfying the threshold, then the region mapping data and/or the calibration of the sensor may be updated based on the offset. For example, a correction to the region mapping data 114 and/or the calibration of the sensor (e.g., by adjusting the sensor pose transform 404, sensor calibration data 118, or extrinsic parameter(s)) that accounts for the offset may be applied.

The method 800 can be repeated to reevaluate the calibration of the sensor at any point. Further, while the method 800 is described as being implemented by pointing the target projector at the sensor itself, it should be understood that the method 800 can also be performed by pointing the target projector at any reference point that is known in both the coordinate system of the target projector and the coordinate system of the sensor. For example, the method 800 may be performed by determining the offset between the 3D position of a target when pointed at one of the predefined points 302 that define a boundary and an expected position of that predefined point.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated measurements and/or sensor data may be used that includes the application of realistic region mapping data and/or sensor calibration data generated within the simulation environment, and may use this information to perform operations (e.g., validation, calibration, etc.) associated with the virtual machine within the environment. These simulated operations may be used to test performance of the underlying algorithms, systems, and/or processes prior to deploying them in the real world. In some instances, the simulation may be used to generate synthetic calibration data—e.g., calibration data including regions of interest and/or subregions of interest from within the simulation. The synthetic calibration data (in addition to or alternatively from real-world data) may then be processed to calibrate a sensor for gaze regions of the driver and/or other occupant, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs) and/or one or more vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J 3016-201806, published on Jun. 15, 2018, Standard No. J 3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to allow the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to allow autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), one or more occupant monitoring system (OMS) sensor(s) 901 (e.g., one or more interior cameras), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.). In some embodiments, one or more components of the calibration data collection system 102 may be implemented at least in part by one or more of the controller(s) 936. In some embodiments, the human-machine interface 106 may comprise HMI display 934.

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

Cameras with a field of view that include portions of the interior environment within the cabin of the vehicle 900 (e.g., one or more OMS sensor(s) 901) may be used as part of an occupant monitoring system (OMS) such as, but not limited to, a driver monitoring system (DMS). For example, OMS sensors (e.g., the OMS sensor(s) 901) may be used (e.g., by the controller(s) 936) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle). In some embodiments, the sensor 502 and/or other image sensors used in conjunction with the calibration data collection system 102 may comprise an OMS sensor 901 and/or other cameras described with respect to FIGS. 9A and 9B.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D). In some embodiments, one or more functions of the calibration data collection system 102 and/or the sensor calibrator 500 may be executed, at least in part, by the SoC 904, CPU(s) 906, and/or GPU(s) 908.

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation allowing any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF 64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 904 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LiDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 916 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to allow communication with peripherals, audio codecs, power management, and/or other devices. The SoC(s) 904 may be used to process data from cameras (e.g., connected over Gigabit Multimedia Serial Link and Ethernet), sensors (e.g., LiDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to allow wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated using the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LiDAR sensor(s) 964. The LiDAR sensor(s) 964 may be used for object and pedestrian detection, emergency braking, collision avoidance, and/or other functions. The LiDAR sensor(s) 964 may be functional safety level ASIL B. In some examples, the vehicle 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900 m, with an accuracy of 2 cm-3 cm, and with support for a 900 Mbps Ethernet connection, for example. In some examples, one or more non-protruding LiDAR sensors 964 may be used. In such examples, the LiDAR sensor(s) 964 may be implemented as a small device that may be embedded into the front, rear, sides, and/or corners of the vehicle 900. The LiDAR sensor(s) 964, in such examples, may provide up to a 120-degree horizontal and 35-degree vertical field-of-view, with a 200 m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may allow the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LiDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. As such, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(D) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. In some embodiments, one of more functions of the calibration data collection system 102 described herein may be performed using a computing device 1000. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof. In some embodiments, one or more functions of the calibration data collection system 102 and/or the sensor calibrator 500 may be executed, at least in part, by the CPU(s) 1006, and/or GPU(s) 1008.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008. In some embodiments, one or more functions of the calibration data collection system 102 and/or the sensor calibrator 500 may be executed, at least in part, by the logic unit(s) 1020.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R. s”) 1116(1)-1116(N), where “N” represents any whole, positive integer. In at least one embodiment, node C.R. s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R. s 1116(1)-1116(N) may correspond to a server having one or more of the above-mentioned computing resources. In addition, in some embodiments, the node C.R. s 1116(1)-1116(N) may include one or more virtual components, such as vGPUs, vCPUs, and/or the like, and/or one or more of the node C.R. s 1116(1)-1116(N) may correspond to a virtual machine (VM). In some embodiments, one or more functions of the calibration data collection system 102 and/or the sensor calibrator 500 may be implemented using one or more of the node C.R. s 1016(1)-1016(N) (e.g., one or more of the functions may be a service available from a cloud computing platform such as implemented by the datacenter 1100).

In at least one embodiment, grouped computing resources 1114 may include separate groupings of node C.R. s 1116 housed within one or more racks (not shown), or many racks housed in data centers at various geographical locations (also not shown). Separate groupings of node C.R. s 1116 within grouped computing resources 1114 may include grouped compute, network, memory or storage resources that may be configured or allocated to support one or more workloads. In at least one embodiment, several node C.R. s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R. s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark^{TM} (hereinafter “Spark”) that may use distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R. s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R. s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
control a target projector to cause a projection of a target to appear at predefined points defining a boundary of a region within an environment;
determine a three-dimensional (3D) position corresponding to a location of the projection of the target;
generate region mapping data in a coordinate system of the target projector comprising 3D coordinates of the predefined points defining the boundary of the region based at least on the 3D position; and
calibrate at least one sensor located within the environment based at least on a transformation of the region mapping data from the coordinate system of the target projector to a coordinate system of the at least one sensor.

2. The one or more processors of claim 1, wherein the predefined points defining the boundary of the region correspond to one or more labeled surfaces within the environment.

3. The one or more processors of claim 1, wherein the processing circuitry is further to determine a position and an orientation of the at least one sensor in the coordinate system based at least on a fiducial marker on the target projector.

4. The one or more processors of claim 1, wherein the target projector comprises a range-finding sensor, wherein the processing circuitry is further to determine the 3D position corresponding to the location of the projection of the target based at least on a distance measured by the range-finding sensor.

5. The one or more processors of claim 4, wherein the 3D position corresponding to the location of the projection of the target includes at least one of: an azimuth component, an elevation component, or the distance measured by the range-finding sensor.

6. The one or more processors of claim 1, wherein the processing circuitry is further to:
control the target projector to cause a projection of a target to appear at one or more points corresponding to a location of the at least one sensor; and
determine an offset between the 3D position corresponding to the location of the projection of the target at the one or more points and an expected position of the at least one sensor.

7. The one or more processors of claim 6, wherein the processing circuitry is further to update, based at least on the offset, one or more of the region mapping data or calibration of the at least one sensor.

8. The one or more processors of claim 6, wherein the processing circuitry is further to:
determine whether the offset satisfies a threshold; and
validate, based at least on a determination that the offset satisfies the threshold, at least one of the region mapping data or calibration of the at least one sensor.

9. The one or more processors of claim 1, wherein the processing circuitry is further to:
control the target projector to cause the projection of the target to appear at predefined points defining a boundary of a second region within the environment;
generate additional region mapping data in the coordinate system of the target projector based at least on the 3D position corresponding to the location of the projection of the target, wherein the additional region mapping data comprises 3D coordinates of the predefined points defining the boundary of the second region; and
calibrate the at least one sensor located within the environment based at least on a transformation of the additional region mapping data from the coordinate system of the target projector to the coordinate system of the at least one sensor.

10. The one or more processors of claim 1, wherein the processing circuitry is further to restore a localization of the at least one sensor in the region mapping data after moving the target projector by:
generating a partial region mapping scan comprising 3D positions corresponding to the location of the projection of the target when directed towards at least three predefined points defining the boundary of the region;
localizing the at least one sensor in the partial region mapping scan based at least on one or more fiducial markers on the target projector; and
aligning the region mapping data with the partial region mapping scan.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processors to:
control a target projector to cause a projected target to appear at a set of predefined points on a boundary of a region;
generate region mapping data in a first coordinate system based at least on a three-dimensional (3D) position corresponding to a location of the projected target, wherein the region mapping data comprises 3D coordinates of the set of predefined points on the boundary of the region; and
calibrate at least one sensor based at least on a transformation of the region mapping data from the first coordinate system to a second coordinate system.

13. The system of claim 12, wherein the one or more processors are further to:
control the target projector to cause the projected target to appear at a second set of predefined points on a boundary of a second region;
generate additional region mapping data in the first coordinate system based at least on the 3D position corresponding to the location of the projected target, wherein the additional region mapping data comprises 3D coordinates of the second set of predefined points on the boundary of the second region; and
calibrate the at least one sensor based at least on a transformation of the additional region mapping data from the first coordinate system to the second coordinate system.

14. The system of claim 12, wherein the 3D position includes a distance measured by a range-finding sensor of the target projector.

15. The system of claim 12, wherein the one or more processors are further to localize the at least one sensor based at least on a fiducial marker on the target projector.

16. The system of claim 12, wherein the one or more processors are further to validate one or more of the region mapping data or calibration of the at least one sensor based at least on an offset between the projected target and a known position of the at least one sensor.

17. The system of claim 12, wherein, after calibration of the at least one sensor, the one or more processors are further to:
control the target projector to cause the projected target to appear on a surface of an interior space within the boundary of the region using the target projector;
capture an image of the interior space using the at least one sensor, wherein the image captures a gaze of an occupant responsive to projection of the projected target;
determine a position in a 3D space corresponding to the location of the projected target; and
label the image of the occupant of the interior space based at least on the position in the 3D space.

18. The system of claim 12, wherein the at least one sensor comprises at least one of: an RGB optical sensor, an IR optical sensor, or an RGB-IR optical sensor.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
calibrating one or more sensors based at least on a transformation of region mapping data from a coordinate system of a target projector to a coordinate system of the one or more sensors, wherein the region mapping data includes 3D coordinates of predefined points on a boundary of a region in the coordinate system of the target projector.
